(19) United States
(12) Patent Application Publication
(10) Pub. No.: US 2009/0021193 A1
(43) Pub. Date: Jan. 22, 2009

(54) DC Motor with a Rotation Direction Switching Circuit

(76) Inventors: Chi-Yuan Cheng, Taichung (TW); Wei-Yun Chiang, Taichung (TW)

Correspondence Address: Dr. BANGER SHIA, 102 Lindencrest Ct., Sugar Land, TX, 77479-5201, US

(21) Appl. No.: 11/778,625

(22) Filed: Jul. 16, 2007

(51) Int. Cl. H02P 7/00; H02P 1/00

(52) U.S. Cl. 318/280

(57) ABSTRACT

A DC motor with a rotation direction switching circuit comprises a second power semiconductor assembly and a first power semiconductor assembly which are switched on and off alternatively by changing the polarity of the DC power source, thus providing an electronic rotation direction switching method. The service life is prolonged and the replacement times relatively reduce, and as a result, the material cost and maintenance cost of the rotation direction switching circuit is reduced. Therefore, it can improve the willingness of the user to use the DC motor with the rotation direction switching circuit and relatively improve the economic value of the DC motor.

### BACKGROUND OF THE INVENTION

1. Field of the Invention

The present invention relates to a DC motor, and more particularly to a DC motor with a rotation direction switching circuit.

2. Description of the Prior Art

The characteristic of DC (direct current) is that its working direction is constant, however, the function of a DC motor is to convert electric power into mechanical power, and the DC motor generally comprises a DC generator for converting mechanic power into electric power and a DC motor for converting electric power into mechanical power.

The power source of the DC motor P10 (as shown in FIG. 1) is a DC power source P20 with positive and negative polarities. For easy switching the rotation direction by changing the polarity, the DC motor P10 is electrically connected to a relay P30, and with the relay P30, the rotation direction of the DC motor P10 can be controlled. However, after study, we found that the relay P30 still has the following disadvantages:

First, the junction temperature of the relay P30 increases with the increase of times of switching, when the temperature exceeds the fusion temperature of the junction, the relay will be damaged, and this will increase the material cost and the time and maintenance cost. And if the damage spreads to the neighboring equipment, the loss will be much larger.

Second, sparks will occur at the junction of the relay P30 at the instant the relay is powered on or off, and this will cause fire and explosion at the place where smoke and fire are strictly forbidden. If the reliability and service life of the relay P30 are unable to meet the user's requirement, the user will be unwilling to use the DC motor P10 with the relay P30, and thus relatively reducing the economic value of the DC motor P10.

The present invention has arisen to mitigate and/or obviate the afore-described disadvantages.

### SUMMARY OF THE INVENTION

The primary objective of the present invention is to provide a DC motor with a rotation direction switching circuit, which is capable of reducing the switching time and improving the switching efficiency.

To achieve the abovementioned objective, the first power semiconductor assembly and the second power semiconductor drive assembly of the rotation direction switching circuit are electrically connected to the DC power source and provide an electronic switching method, which not only solves the problem of slow switching operation and sparks caused by the mechanical switching operation, but also prevents the high temperature and fusion problem.

The secondary objective of the present invention is to provide a DC motor with a rotation direction switching circuit, which not only has a higher applicability but also improves the economic value.

To achieve the abovementioned objective, the first power semiconductor assembly and the second power semiconductor drive assembly of the rotation direction switching circuit are electrically connected to the DC power source and provide an electronic switching method, which not only solves the problem of the slow switching operation and sparks caused by the mechanical switching operation, but also improves the applicability of the rotation direction switching circuit. Therefore, it can improve the willingness of the user to use the DC motor with the rotation direction switching circuit and relatively improve the economic value of the DC motor.

### BRIEF DESCRIPTION OF THE DRAWINGS

FIG. 1 is a circuit diagram of a conventional rotation direction switching circuit; and

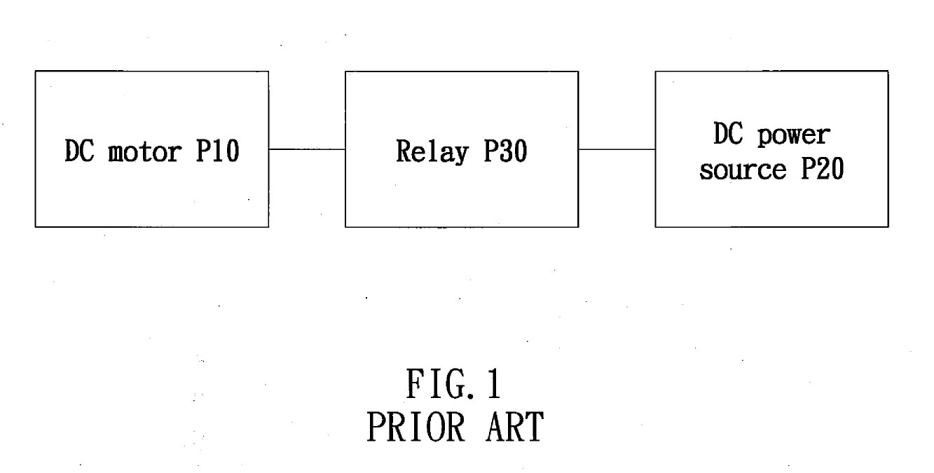

FIG. 2 is a circuit diagram of a DC motor with a rotation direction switching circuit in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

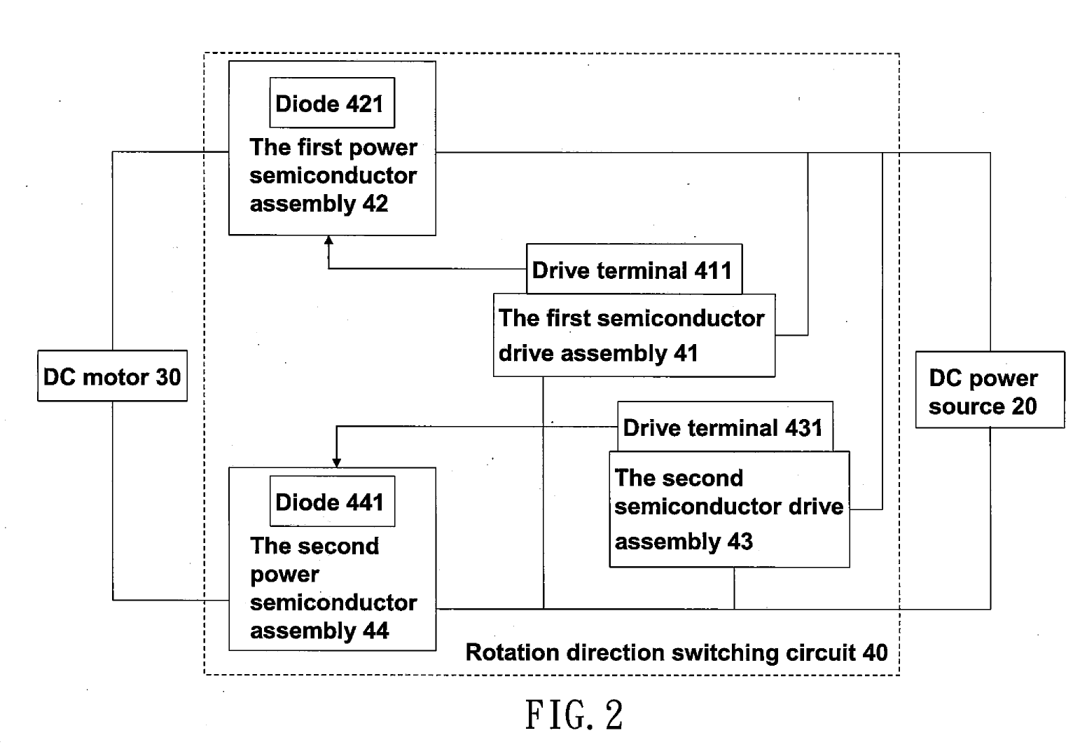

Referring to FIG. 2, a DC motor with a rotation direction switching circuit in accordance with the present invention is used to switch the rotation direction of a brake device but is not limited to the brake device. The DC motor with a rotation direction switching circuit comprises a DC power source 20, a DC motor 30, and a rotation direction switching circuit 40.

The DC motor 30 is connected in parallel to the DC power source 20 and serves to convert electric power into mechanical power.

The rotation direction switching circuit 40 includes a first power semiconductor drive assembly 41, a first power semiconductor assembly 42, a second semiconductor drive assembly 43, and a second power semiconductor assembly 44.

The first power semiconductor drive assembly 41 is a photo coupler that includes a transistor and a LED (light emitting diode) and is connected in parallel to the DC motor 30. The first power semiconductor drive assembly 41 has a drive terminal 411.

The first power semiconductor assembly 42 is a MOSFET (Metal Oxide Semiconductor Field Effect Transistor) connected in series to a circuit between the first semiconductor drive assembly 41 and one terminal of the DC motor 30 and includes a diode 421. The first power semiconductor assembly 42 is connected to the drive terminal 411 of the first power semiconductor drive assembly 41.

The second power semiconductor drive assembly 43 is a photo coupler that includes a transistor and a LED and is connected in parallel to the DC motor 30. The second power semiconductor drive assembly 43 has a drive terminal 431.

The second power semiconductor assembly 44 is a MOSFET (Metal Oxide Semiconductor Field Effect Transistor) connected in series to a circuit between the second semiconductor drive assembly 43 and the other terminal of the DC motor 30 and includes a diode 441. The second power semiconductor assembly 44 is connected to the drive terminal 431 of the second power semiconductor drive assembly 43.

For a better understanding of the present invention, its operation and function, please refer to the following descriptions about how to change to positive and negative input modes A and B by switching the polarity of the DC power source 20.

A. positive input modes: When the DC power 20 outputs positive power, the second power semiconductor drive assembly 43 operates, and its drive terminal 431 drives and electrifies the second power semiconductor assembly 44. The current flows through the diode 421 of the first power semiconductor assembly 42 to the DC motor 30 and then to the second power semiconductor assembly 44, and through the abovementioned operation, a clockwise rotation circuit is closed.

B. negative input modes: When the DC power 20 outputs negative power, the second power semiconductor assembly 44 operates, and its drive terminal 411 drives and electrifies the first power semiconductor assembly 42. The current flows through the diode 441 of the second power semiconductor assembly 44 to the DC motor 30 and then to the first power semiconductor assembly 42, and through the abovementioned operation, a counter-clockwise rotation circuit is closed.

The second power semiconductor assembly 44 and the first power semiconductor assembly 42 are switched on and off alternatively by changing the polarity of the DC power source 20, and thus the rotation direction of the DC motor 30 is changed. After further studying the operation stated above, it is found that switching the rotation direction of the DC motor 30 with the rotation direction switching circuit 40 can achieve the following functions and effects:

First, the first power semiconductor assembly 42 and the second power semiconductor assembly 44 of the rotation direction switching circuit 40 provide an electronic switching method, thus reducing the switching time while improving the switching efficiency, and preventing the problems caused by the mechanical contact. Accordingly, the service life is prolonged and the replacement times relatively reduces, and as a result, the material cost and maintenance cost of the rotation direction switching circuit 40 is reduced.

Second, due to the semiconductor characteristic, the first power semiconductor assembly 42 and the second power semiconductor assembly 44 of the rotation direction switching circuit 40 provide an electronic type switching method without producing sparks, so that the DC motor 30 can be used in the workplace where smoke and fire are strictly forbidden, thus improving the applicability and safety of the DC motor 30. The user will be willing to use the DC motor 30 with the rotation direction switching circuit 40, and thus relatively improving the economic value of the DC motor 30.

To summarize, a DC motor with a rotation direction switching circuit in accordance with the present invention comprises a second power semiconductor assembly and a first power semiconductor assembly which are switched on and off alternatively by changing the polarity of the DC power source, thus providing an electronic rotation direction switching method. The service life is prolonged and the replacement times relatively reduce, and as a result, the material cost and maintenance cost of the rotation direction switching circuit is reduced. Therefore, it can improve the willingness of the user to use the DC motor with the rotation direction switching circuit and relatively improve the economic value of the DC motor.

While we have shown and described various embodiments in accordance with the present invention, it is clear to those skilled in the art that further embodiments may be made without departing from the scope of the present invention.

What is claimed is:

1. A DC motor with a rotation direction switching circuit comprising:
a DC motor electrically connected to a DC power source; and
a rotation direction switching circuit including a first power semiconductor assembly and a second power semiconductor assembly, the first power semiconductor assembly being connected in series to a circuit between the DC power source and one terminal of the DC motor, the second power semiconductor assembly being connected in series to a circuit between the DC power source and the other terminal of the DC motor, the second power semiconductor assembly and the first power semiconductor assembly are switched on and off alternatively by changing the polarity of the DC power source, and thus the rotation direction of the DC motor is changed.

2. The DC motor with a rotation direction switching circuit as claimed in claim 1 further comprising a first power semiconductor drive assembly and a second power semiconductor drive assembly to be connected in parallel to the DC motor, each of the first and second power semiconductor drive assemblies includes a drive terminal;
the first power semiconductor assembly is connected to the drive terminal of the first power semiconductor drive assembly;
the second power semiconductor assembly is connected to the drive terminal of the second power semiconductor drive assembly.

3. The DC motor with a rotation direction switching circuit as claimed in claim 1, wherein the first power semiconductor drive assembly is a photo coupler.

4. The DC motor with a rotation direction switching circuit as claimed in claim 1, wherein the first power semiconductor assembly is a Metal Oxide Semiconductor Field Effect Transistor.

5. The DC motor with a rotation direction switching circuit as claimed in claim 1, wherein the second power semiconductor drive assembly is a photo coupler.

6. The DC motor with a rotation direction switching circuit as claimed in claim 1, wherein the second power semiconductor assembly is a Metal Oxide Semiconductor Field Effect Transistor.
